(19) United States
(12) Patent Application Publication
(10) Pub. No.: US 2017/0311265 A1
(43) Pub. Date: Oct. 26, 2017

(54) ELECTRONIC DEVICE AND METHOD FOR CONTROLLING THE ELECTRONIC DEVICE TO SLEEP

(71) Applicants: Fu Tai Hua Industry (Shenzhen) Co., Ltd., Shenzhen (CN); HON HAI PRECISION INDUSTRY CO., LTD., New Taipei (TW)

(72) Inventors: TSUNG-JEN CHUANG, New Taipei (TW); JUN ZHANG, Shenzhen (CN); SHUN-FENG YU, Shenzhen (CN)

(21) Appl. No.: 15/497,209

(22) Filed: Apr. 26, 2017

(30) Foreign Application Priority Data
Apr. 26, 2016 (CN) 201610264115.0

(51) Int. Cl. H04W 52/02

(52) U.S. Cl. CPC H04W 52/0254

(57) ABSTRACT

A method for controlling an electronic device to sleep because of user inaction includes checking whether the electronic device is playing streaming media, and detecting distance between the electronic device and a user who is using the electronic device in real time when the electronic device is playing streaming media. Method determines whether the detected distances change in a first predetermined time period, and controls the electronic device to sleep when determining that the detected distances in the first predetermined time period are the same.

### CROSS-REFERENCE TO RELATED APPLICATIONS

This application claims priority to Chinese Patent Application No. 201610264115.0 filed on Jun. 26, 2016, the contents of which are incorporated by reference herein.

### FIELD

The subject matter herein generally relates to electronic device control technology, and particularly to an electronic device and a method for controlling the electronic device to sleep.

### BACKGROUND

Users may like using an electronic device such as smart TV, smart phone, or personal computer, to watch videos or listen to music for fun. However, users can easily fall asleep when watching videos or listening to music, and the video or the music still plays, which leads to waste of power of the electronic device.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an exemplary embodiment of an electronic device.

FIG. 2 illustrates a flowchart of an exemplary embodiment of a method for controlling the electronic device to sleep.

FIG. 3 illustrates a flowchart of another embodiment of the method for controlling the electronic device to sleep.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

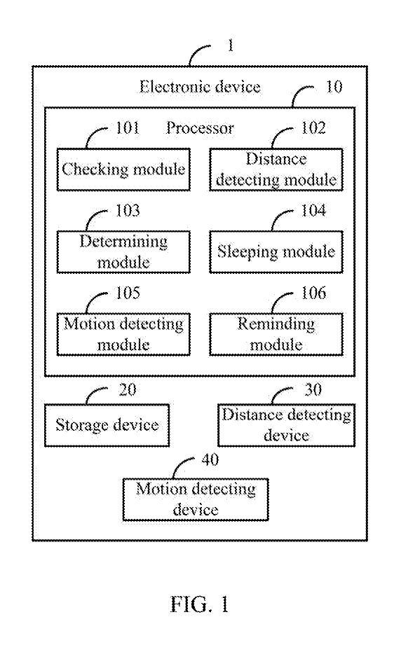

FIG. 1 illustrates a block diagram of an exemplary embodiment of an electronic device 1. The electronic device 1 includes, but is not limited to, a processor 10, a storage device 20, a distance detecting device 30, and a motion detecting device 40. In at least one exemplary embodiment, the electronic device 1 can be a smart phone, a personal computer, or a smart television. FIG. 1 illustrates only one example of the electronic device 1, other examples can include more or fewer components than illustrated, or have a different configuration of the various components in other embodiments.

In at least one exemplary embodiment, the storage device 20 can include various types of non-transitory computer-readable storage mediums. For example, the storage device 20 can be an internal storage system, such as a flash memory, a random access memory (RAM) for temporary storage of information, and/or a read-only memory (ROM) for permanent storage of information. The storage device 20 can also be an external storage system, such as a hard disk, a storage card, or a data storage medium. The at least one processor 10 can be a central processing unit (CPU), a microprocessor, or other data processor chip that performs functions of the electronic device 1.

In at least one exemplary embodiment, the distance detecting device 30 can be an infrared sensor, the distance detecting device 30 is used to transmit infrared rays and receive reflected infrared rays. In other embodiments, the distance detecting device 30 also can be an ultrasonic wave sensor.

In at least one exemplary embodiment, the motion detecting device 40 can be a camera, the motion detecting device 40 is used to capture images of surroundings around the electronic device 1.

As illustrated in FIG. 1, the electronic device 1 includes a checking module 101, a distance detecting module 102, a determining module 103, a sleeping module 104, a motion detecting module 105, and a reminding module 106. The modules 101-106 can be collections of software instructions stored in the storage device 20 of the electronic device 1 and executed by the processor 10. The modules 101-106 also can include functionality represented as hardware or integrated circuits, or as software and hardware combinations, such as a special-purpose processor or a general-purpose processor with special-purpose firmware.

The checking module 101 is used to check whether the electronic device 1 is playing streaming media.

In at least one exemplary embodiment, the streaming media at least include video and audio. The checking module 101 determines whether the electronic device 1 is playing the streaming media by checking whether the electronic device 1 is executing at least one streaming media file. When the electronic device 1 is executing the streaming media file, the checking module 101 can determine that the electronic device 1 is playing the streaming media. When the electronic device 1 is not executing the streaming media file, the checking module 101 can determine that the electronic device 1 is not playing the streaming media.

When the electronic device 1 is playing the streaming media, the distance detecting module 102 is used to control the distance detecting device 30 to detect the distance between the electronic device 1 and a user of the electronic device 1, in real time.

In at least one exemplary embodiment, the distance detecting module 102 transmits infrared rays to detect the user. When the infrared rays arrive at the user, the infrared rays are reflected, then the distance detecting device 30 receives the reflected infrared rays. According to transmission speed of the infrared rays and time interval between the time that the distance detecting device 30 transmits the infrared rays and the time that the distance detecting device 30 receives the reflected infrared rays, the distance detecting device 30 calculates the distance between the electronic device 1 and the user.

The determining module 103 is used to determine whether the distances detected by the distance detecting device 30 in a first predetermined time period are the same.

In at least one exemplary embodiment, the distance data between the electronic device 1 and the user detected by the distance detecting device 30 are stored in the storage device 20. The determining module 103 can acquire a number of distance data detected by the distance detecting device 30 in the first predetermined time period from the storage device 20, and compare information within the number of distance data. When the distances within the distance data are the same, the determining module 103 determines that the detected distances in the first predetermined time period are the same. In at least one exemplary embodiment, the first predetermined time period can be five minutes. In other embodiments, the first predetermined time period can be any other values.

When the determining module 103 determines that the detected distances in the first predetermined time period are the same, the sleeping module 104 is used to control the electronic device 1 to sleep.

In at least one exemplary embodiment, when the detected distances in the first predetermined time period are the same, this represents an unmoving user, who may have fallen asleep. At this time, the sleeping module 104 controls the electronic device 1 to sleep, for power saving and for not disturbing the user.

In another embodiment, when the determining module 103 determines that the detected distances in the first predetermined time period are the same, the motion detecting module 105 is used to control the motion detecting device 40 to detect motion of the user in real time.

In at least one exemplary embodiment, the motion detecting device 40 can detect any motion of the user by capturing the images of surroundings in a predetermined range of the electronic device 1. In at least one exemplary embodiment, the predetermined range can be changed according to the focal length of the motion detecting device 40.

The determining module 103 is further used to determine whether the motions of the user detected by the motion detecting device 40 in a second predetermined time period are the same.

In at least one exemplary embodiment, the images of surroundings in the predetermined range of the electronic device 1 captured by the motion detecting device 40 are stored in the storage device 20. The determining module 103 can acquire a number of images of surroundings in the predetermined range of the electronic device 1 in the second predetermined time period from the storage device 20, and compare characteristics of the number of images. When the characteristics in the number of images are unchanged, the determining module 103 determines that the motions of the user detected by the motion detecting device 40 in the second predetermined time period are the same. In at least one exemplary embodiment, the second predetermined time period can be five minutes. In other embodiments, the second predetermined time period can be any other values.

When the determining module 103 determines that the detected distances in the first predetermined time period and the detected motions of the user in the second predetermined time are the same, the sleeping module 104 is used to control the electronic device 1 to sleep.

In at least one exemplary embodiment, when the detected distances in the first predetermined time period and the detected motions of the user in the second predetermined time are substantially the same, this is taken as an indication that the user may have fallen asleep. At this time, the sleeping module 104 controls the electronic device 1 to sleep, for power saving and so as not to disturb the user.

Furthermore, when the determining module 103 determines that the detected distances in the first predetermined time period and the detected motions of the user in the second predetermined time are the same, the reminding module 106 is used to output a message to the user that the electronic device 1 is going to sleep.

In at least one exemplary embodiment, the message can be text message which is displayed on an operation interface of the electronic device 1. For example, the reminding module 106 can output a pop-up information including a text message of “Going to sleep” and an option to cancel the sleeping. In other embodiments, the message also can be a soft voice message output by the electronic device 1. In other embodiments, the reminding module 106 can output the text message and the voice message at the same time.

The determining module 103 is further used to determine whether the user does respond to the message in a third predetermined time period. For example, when the reminding module 106 outputs the pop-up message, the user can respond the by clicking the option to cancel the sleeping in the third predetermined time period. The electronic device 1 then does not sleep. When the reminding module 106 outputs the voice message, the user can respond to the message by answering the voice message in the third predetermined time period, to avoid the electronic device 1 going to sleep. When the user does not respond to the message in the third predetermined time period, the sleeping module 104 controls the electronic device 1 to sleep. In at least one exemplary embodiment, the third predetermined time period can be one minute. In other embodiments, the third predetermined time period can be any other values.

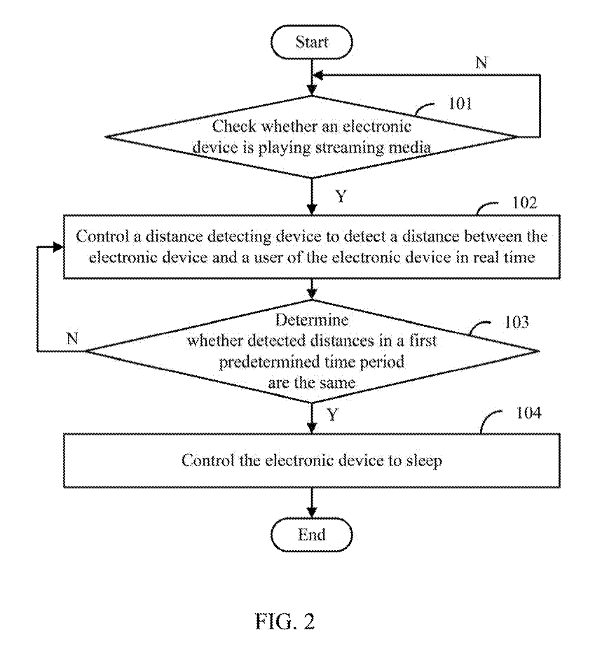

FIG. 2 illustrates a flowchart of an exemplary embodiment of a method for controlling an electronic device to sleep. The method is provided by way of example, as there are a variety of ways to carry out the method. The method described below can be carried out using the configurations illustrated in FIG. 1, for example, and various elements of these figures are referenced in explaining the example method. Each block shown in FIG. 2 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 101.

At block 101, a checking module checks whether an electronic device is playing streaming media.

At block 102, when the electronic device is playing the streaming media, a distance detecting module controls a distance detecting device 30 to detect the distance between the electronic device and a user of the electronic device in real time.

At block 103, a determining module determines whether the distances detected by the distance detecting device 30 in a first predetermined time period are the same. If the detected distances in the first predetermined time period are the same, the process jumps to block 104. If the detected distances in the first predetermined time period are not the same, the process returns to block 102.

At block 104, a sleeping module controls the electronic device to sleep.

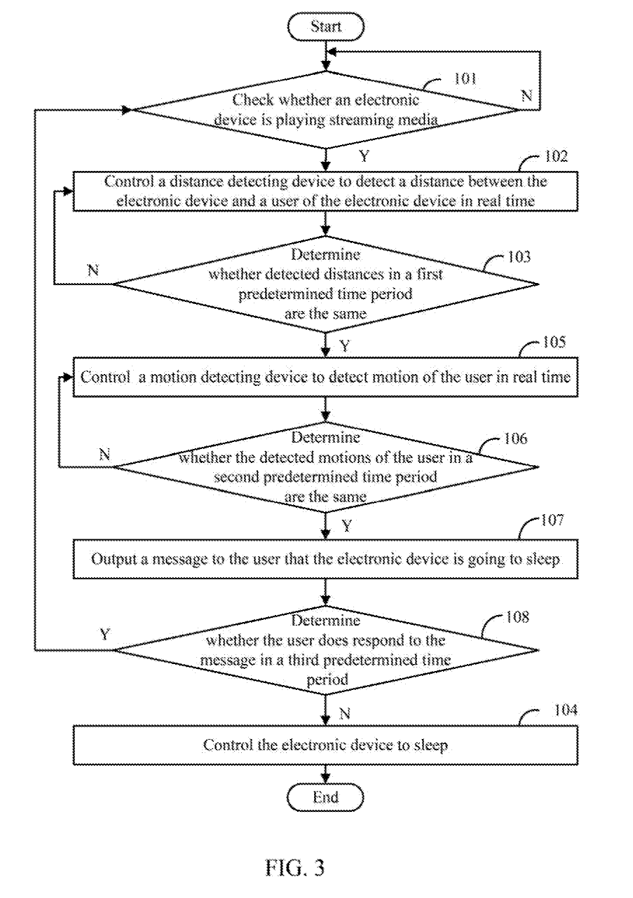

FIG. 3 illustrates a flowchart of another embodiment of a method for controlling the electronic device to sleep. The example method further includes blocks 105-108.

At block 105, when the determining module determines that the detected distances in the first predetermined time period are the same, a motion detecting module controls a motion detecting device to detect motion of the user in real time.

At block 106, the determining module further determines whether the motions of the user detected by the motion detecting device in a second predetermined time period are the same. If the motions of the user detected by the motion detecting device in the second predetermined time period are the same, the process jumps to block 107. If the motions of the user detected by the motion detecting device in the second predetermined time period are not the same, the process returns to block 105.

At block 107, a reminding module outputs a message to the user that the electronic device is going to sleep.

At block 108, the determining module further determines whether the user does respond to the message in a third predetermined time period. If the user does not respond to the message in the third predetermined time period, the process returns to block 101. If the user responds to the reminding message in the third predetermined time period, the process jumps to block 104.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device comprising:
at least one processor;
a distance detecting device coupled to the at least one at least one processor; and
a storage device coupled to the at least one processor and storing instructions for execution by the at least one processor to cause the at least one processor to:
check whether the electronic device is playing streaming media;
control, when the electronic device is playing the streaming media, the distance detecting device to detect a distance between the electronic device and a user of the electronic device in real time;
determine whether distances detected by the distance detecting device in a first predetermined time period are the same; and
control, when determining that the detected distances in the first predetermined time period are the same, the electronic device to sleep.

2. The electronic device according to claim 1, wherein the at least one processor is further caused to:
acquire a plurality of distance data detected by the distance detecting device in the first predetermined time period;
compare information within the distance data; and
determine, when the distances within the distance data are the same, that the detected distances in the first predetermined time period are the same.

3. The electronic device according to claim 1, further comprising:
a motion detecting device coupled to the at least one processor;
wherein the at least one processor is further caused to:
control, when determining that the detected distances in the first predetermined time period are the same, the motion detecting device to detect motion of the user in real time.

4. The electronic device according to claim 3, wherein the at least one processor is further caused to:
determine whether motions of the user detected by the motion detecting device in a second predetermined time period are the same; and
control, when determining that the detected distances in the first predetermined time period and the detected motions of the user in the second predetermined time are the same, the electronic device to sleep.

5. The electronic device according to claim 4, wherein the motion detecting device is a camera, the at least one processor is further caused to:
acquire a plurality of images of surroundings in a predetermined range of the electronic device in the second predetermined time period;
compare characteristics of the plurality of images; and
determine, when the characteristics in the plurality of images are unchanged, that the motions of the user detected by the motion detecting device in the second predetermined time period are the same.

6. The electronic device according to claim 4, wherein the at least one processor is further caused to:
output, when determining that the detected distances in the first predetermined time period and the detected motions of the user in the second predetermined time are the same, a message to the user that the electronic device is going to sleep;
determine whether the user does respond to the message in a third predetermined time period; and
control, when the user does not respond to the message in the third predetermined time period, the electronic device to sleep.

7. A method for controlling an electronic device to sleep comprising:
checking whether the electronic device is playing streaming media;
controlling a distance detecting device to detect a distance between the electronic device and a user of the electronic device in real time, when the electronic device is playing the streaming media;
determining whether distances detected by the distance detecting device in a first predetermined time period are the same; and
controlling the electronic device to sleep when determining that the detected distances in the first predetermined time period are the same.

8. The method according to claim 7, wherein determining whether distances detected by the distance detecting device in a first predetermined time period are the same comprises:
acquiring a plurality of distance data detected by the distance detecting device in the first predetermined time period;
comparing information within the distance data; and
determining that the detected distances in the first predetermined time period are the same when the distances within the distance data are the same.

9. The method according to claim 7, further comprising:
controlling a motion detecting device to detect motion of the user in real time, when determining that the detected distances in the first predetermined time period are the same;
determining whether motions of the user detected by the motion detecting device in a second predetermined time period are the same; and
controlling the electronic device to sleep when determining that the detected distances in the first predetermined time period and the detected motions of the user in the second predetermined time are the same.

10. The method according to claim 9, wherein determining whether the motions of the user detected by the motion detecting device in a second predetermined time period are the same comprises:
acquiring a plurality of images of surroundings in a predetermined range of the electronic device in the second predetermined time period;
comparing characteristics of the plurality of images; and
determining that the motions of the user detected by the motion detecting device in the second predetermined time period are the same, when the characteristics in the plurality of images are unchanged.

11. The method according to claim 9, further comprising:
outputting a message to the user that the electronic device is going to sleep, when determining that the detected distances in the first predetermined time period and the detected motions of the user in the second predetermined time period are the same;
determining whether the user does respond to the message in a third predetermined time period; and
controlling the electronic device to sleep when the user does not respond to the message in the third predetermined time period.
